(19) United States
(12) Patent Application Publication
(10) Pub. No.: US 2025/0098712 A1
(43) Pub. Date: Mar. 27, 2025

(54) NON-ALCOHOLIC WINE BEVERAGE INCLUDING BLENDS OF NITROGEN AND CARBON DIOXIDE

(71) Applicant: INVINITY LLC, City of Industry, CA (US)

(72) Inventors: Donald F. Wilkes, City of Industry, CA (US); Kelly Chavarrio, City of Industry, CA (US)

(21) Appl. No.: 18/372,562

(22) Filed: Sep. 25, 2023

(51) Int. Cl. A23L 2/54; A23L 2/02; A23L 2/38

(52) U.S. Cl. CPC A23L 2/54; A23L 2/02; A23L 2/38

(57) ABSTRACT

A non-alcoholic wine beverage. The non-alcoholic wine beverage may include a dealcoholized wine base of a desired wine varietal. Other ingredients, such as sugars, fruit juices, acids, antioxidants, and other flavorings also may be added. The resulting beverage is then carbonated using a precise blend of nitrogen and carbon dioxide, depending on the varietal, to create a mouthfeel, taste, and finish that replicates traditional alcoholic wines.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to beverages, including non-alcoholic wine beverages.

### BACKGROUND OF THE INVENTION

Wine has been consumed throughout the world for centuries. And as is widely known, wine may contain alcohol which may produce both desirable and undesirable effects on the consumer.

For example, the consumption of alcohol may cause temporary euphoria and may relieve symptoms of anxiety by depressing the central nervous system. However, as the temporary benefits wear off, an increase of anxiety, irritability and even depression may result. This also may lead to alcohol abuse disorders.

In addition, alcohol is known to increase the risk of heart disease, liver disease, cancer, and other diseases. Alcohol also causes shrinkage in the hippocampus, the brain area associated with memory and reasoning, and is linked to an increased risk of dementia and Alzheimer's disease.

Alcohol also is highly addictive and may lead to depression and other mental and/or mood disorders. Over time, with more drinking, the dopamine effect may diminish until it's almost nonexistent. However, at this stage, the consumer may often experience a strong compulsive need to continue drinking, often in excess, resulting in addiction and alcohol abuse disorders.

According to results from the 2001-2002 National Epidemiologic Survey on Alcohol and Related Conditions (NESARC), about 10% of men and 3%-5% of women become alcoholics over the course of their lifetime.

Accordingly, there is a need for a non-alcoholic wine beverage. The presently disclosed beverage addresses these needs.

### DETAILED DESCRIPTION OF THE PREFERRED EMBODIMENTS

For the purposes of this specification, the term “non-alcoholic” wine generally refers to a wine derived beverage having less than 0.5% alcohol content as considered by the Bureau of Alcohol, Tobacco Products and Firearms Division of the U.S. Treasury Department. It is also understood that if this limit varies at any time, then the term “non-alcoholic” as used herein may also vary accordingly.

As is known in the art, the term “mouthfeel” refers to the physical sensations in the mouth caused by food or drink (making mouthfeel distinct from taste). Mouthfeel is a fundamental sensory attribute, which, along with taste and smell, determines the overall flavor and experience of the food or drink. For traditional wines, mouthfeel is typically influenced by the levels of alcohol, glycerol, sugar, proteins, and tannins in the wine.

In general, and according to exemplary embodiments hereof, non-alcoholic wine beverages are provided. The ingredients provided and the processes used to produce the beverages have been developed to result in one or more varietals of non-alcoholic wines that resemble their traditional wine counterparts in both mouthfeel, taste, and finish.

In some embodiments, the non-alcoholic wine beverage includes a dealcoholized red wine base prepared from Cabernet Sauvignon, Merlot, Pinot Noir, Claret, Sangiovese, and/or other red wine varietals. In other embodiments, the wine beverage includes a dealcoholized white wine base prepared from Sauvignon Blanc, Chardonnay, and/or other white wine varietals. It is understood by a person of ordinary skill in the art that the wine beverage may include a wine base that may be prepared from any wine varietals, from any combination of wine varietals, or from other types of bases, and that the scope of the wine beverage is not limited in any way by the type or combinations of types of wine varietals that may be used.

The wine base may be dealcoholized, e.g., using a Spinning Cone Column, a membrane reverse osmosis process, and/or any other techniques or combinations thereof. In any event, it is preferable that the resulting dealcoholized wine beverage contain no more than about 0.5% alcohol.

In some embodiments hereof, the beverage includes as a base, among other ingredients, the non-alcoholic wine beverage described in U.S. Pat. No. 9,445,623 filed on Apr. 30, 2009, the entire contents of which are hereby fully incorporated herein by reference for all purposes.

The inventor of the non-alcoholic beverages according to exemplary embodiments hereof has discovered that using a precise mixture of nitrogen and carbon dioxide to carbonate each of the beverages (instead of using carbon dioxide alone which is the common practice) results in flavor and mouthfeel characteristics that best resemble those of traditional alcoholic wines. In some embodiments as described herein, the blend ratios of the nitrogen and carbon dioxide are chosen depending on the varietal of dealcoholized wine base that is used. In this way, each non-alcoholic wine beverage is optimized to best resemble the varietal that it is meant to replicate.

The inventor also has discovered that as the nitrogen level within the carbonation gas blend of nitrogen and carbon dioxide is increased with respect to the carbon dioxide, the overall bubble size of the resulting carbonation is reduced, resulting in a mouthfeel that better resembles the carbonation resulting from natural fermentation of traditional wines. The smaller bubble size also imparts a full-bodied creaminess to the finished beverage.

As described herein, the non-alcoholic wine beverages according to exemplary embodiments hereof may include one or more varietals, including, but not limited to, Sauvignon Blanc, Rose', and Cabernet Sauvignon, with each varietal including a unique blend of nitrogen and carbon dioxide as its carbonating gas. Other varietals also may be created using the same or similar carbonating gas blends of nitrogen and carbon dioxide.

The non-alcoholic wine beverage according to exemplary embodiments hereof will now be described in detail with respect to the different types of wine varietals that may be used to form the beverages.

### Cabernet Sauvignon

In some embodiments, the non-alcoholic wine beverage includes a Cabernet Sauvignon dealcoholized wine base. The added ingredients and the carbonation gas blend are chosen to optimize the resemblance of the non-alcoholic Cabernet Sauvignon wine beverage to its traditional alcoholic counterpart.

In some embodiment, the ingredients of the Cabernet Sauvignon non-alcoholic wine beverage include (without limitation):

Dealcoholized Cabernet Sauvignon wine base;

Cane sugar;

Tartaric acid;

A blend of dark red fruit juices;

A blend of dark fruit flavors;

Red wine concentrate powder;

Antioxidants;

Water (as needed); and

Other ingredients.

In addition to the above, the Cabernet Sauvignon non-alcoholic wine beverage may include a blend of nootropic functional ingredients to enhance focus, clarity, mood, and overall brain health.

For example, in some embodiments, the Cabernet Sauvignon non-alcoholic wine beverage may include (without limitation):

Lion's Mane Mushroom (preferably full spectrum) in the amount of 50 mg-250 mg per 8 oz serving of the resulting non-alcoholic wine beverage;

L-Theanine in the amount of 100 mg 200 mg per 8 oz serving of the resulting non-alcoholic wine beverage; and

Green and/or black tea extract in an amount that provides 50 mg-100 mg of natural caffeine per 8 oz serving of the resulting non-alcoholic wine beverage.

In some embodiments, the Cabernet Sauvignon non-alcoholic wine beverage is carbonated using a blend of about 60%-90% nitrogen and about 10%-40% carbon dioxide, and preferably about 70%-80% nitrogen and about 20%-30% carbon dioxide, and more preferably about 75% nitrogen and about 25% carbon dioxide. This higher content of nitrogen provides clusters of smaller bubbles within the beverage that bring out the dark dry flavor of the Cabernet Sauvignon wine base.

The Cabernet Sauvignon non-alcoholic wine beverage is batched and pressurized (carbonated) using the above-described gas blend ratios to about 2.6 CO₂ volumes. It is then bottled, and tunnel pasteurized for about 10 minutes at 160° F.

The result is a creamy and full-bodied Cabernet Sauvignon non-alcoholic wine beverage.

### Sauvignon Blanc

In some embodiments, the non-alcoholic wine beverage includes a Sauvignon Blanc dealcoholized wine base. The added ingredients and the carbonation gas blend are chosen to optimize the resemblance of the non-alcoholic Sauvignon Blanc wine beverage to its traditional alcoholic counterpart.

In some embodiments, the ingredients of the Sauvignon Blanc non-alcoholic wine beverage may include (without limitation):

Dealcoholized Sauvignon Blanc wine base;

Cane sugar;

An acid blend;

White grape juice concentrate;

Tropical flavors;

Antioxidants;

Water (as needed); and

Other ingredients.

In addition to the above, the Sauvignon Blanc non-alcoholic wine beverage may include a blend of nootropic functional ingredients to enhance focus, clarity, mood, and overall brain health.

For example, in some embodiments, the Sauvignon Blanc non-alcoholic wine beverage may include (without limitation):

Lion's Mane Mushroom (preferably full spectrum) in the amount of 50 mg-250 mg per 8 oz serving of the resulting non-alcoholic wine beverage;

L-Theanine in the amount of 100 mg200 mg per 8 oz serving of the resulting non-alcoholic wine beverage; and

Green and/or black tea extract in an amount that provides 50 mg-100 mg of natural caffeine per 8 oz serving of the resulting non-alcoholic wine beverage.

The tropical flavors in white wines are complemented by the higher carbon dioxide component of the gas mixture. Thus, in some embodiments, the Sauvignon Blanc non-alcoholic wine beverage can be carbonated using a blend of about 10%-40% nitrogen and about 60%-90% carbon dioxide, and preferably about 20%-30% nitrogen and about 70%-80% carbon dioxide, and more preferably about 25% nitrogen and about 75% carbon dioxide.

The Sauvignon Blanc non-alcoholic wine beverage is batched and pressurized (carbonated) using the above-described gas blend ratios to about 2.6 CO₂ volumes. It is then bottled, and tunnel pasteurized for about 10 minutes at 160° F.

The result is an easy to drink Sauvignon Blanc non-alcoholic wine beverage that is light on the tongue with a clean, crisp finish.

### Rose'

In some embodiments, the non-alcoholic wine beverage includes a Rose' dealcoholized wine base. The added ingredients and the carbonation gas blend are chosen to optimize the resemblance of the non-alcoholic Rose' wine beverage to its traditional alcoholic counterpart.

In some embodiments, the ingredients of the Rose' non-alcoholic wine beverage may include (without limitation):

Dealcoholized Rose' wine base;

Cane sugar;

Citric acid;

A blend of berry juices;

Other flavors;

Antioxidants;

Water (as needed); and

Other ingredients.

In addition to the above, the Rose' non-alcoholic wine beverage may include a blend of nootropic functional ingredients to enhance focus, clarity, mood, and overall brain health.

For example, in some embodiments, the Rose' non-alcoholic wine beverage may include (without limitation):

Lion's Mane Mushroom (preferably full spectrum) in the amount of 50 mg-250 mg per 8 oz serving of the resulting non-alcoholic wine beverage;

L-Theanine in the amount of 100 mg 200 mg per 8 oz serving of the resulting non-alcoholic wine beverage; and

Green and/or black tea extract in an amount that provides 50 mg-100 mg of natural caffeine per 8 oz serving of the resulting non-alcoholic wine beverage.

For Rose wines, a balanced mixture of nitrogen to carbon dioxide can bring out the berry flavors in the wine beverage while mimicking the “drying” finish of alcohol, and the antioxidants impart an astringent finish.

Thus, in some embodiments, the Rose' non-alcoholic wine beverage can be carbonated using a blend of about 40%-60% nitrogen and about 40%-60% carbon dioxide, and preferably about 45%-55% nitrogen and about 45%-55% carbon dioxide, and more preferably about 50% nitrogen and about 50% carbon dioxide

The Rose' non-alcoholic wine beverage is batched and pressurized (carbonated) using the above-described gas blend ratios to about 2.6 CO₂ volumes. It is then bottled, and tunnel pasteurized for about 10 minutes at 160° F.

The result is a sweet and smooth non-alcoholic Rose' wine beverage.

It is understood that any aspect and/or element of any embodiment of the non-alcoholic wine beverage described herein may be combined with any other aspect and/or element of any other embodiment described herein in any way to form additional embodiments of the non-alcoholic wine beverage all of which are within the scope of the non-alcoholic wine beverage.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A non-alcoholic wine beverage comprising:
a dealcoholized wine base;
a blend of fruit juices, and
a blend of carbonation gases comprising a mixture of carbon dioxide and nitrogen.

2. The non-alcoholic wine beverage of claim 1 wherein the dealcoholized wine base includes a dealcoholized Cabernet Sauvignon wine base, and the mixture of carbon dioxide and nitrogen comprises about 70%-80% nitrogen and about 20% 30% carbon dioxide.

3. The non-alcoholic wine beverage of claim 2 wherein the mixture of carbon dioxide and nitrogen includes about 75% nitrogen and about 25% carbon dioxide.

4. The non-alcoholic wine beverage of claim 1 wherein the dealcoholized wine base includes a dealcoholized Sauvignon Blanc wine base, and the mixture of carbon dioxide and nitrogen comprises about 20%-30% nitrogen and about 70%-80% carbon dioxide.

5. The non-alcoholic wine beverage of claim 4 wherein the mixture of carbon dioxide and nitrogen includes about 25% nitrogen and about 75% carbon dioxide.

6. The non-alcoholic wine beverage of claim 1 wherein the dealcoholized wine base includes a dealcoholized Rose' wine base, and the mixture of carbon dioxide and nitrogen comprises about 40%-60% nitrogen and about 40%-60% carbon dioxide.

7. The non-alcoholic wine beverage of claim 6 wherein the mixture of carbon dioxide and nitrogen includes about 50% nitrogen and about 50% carbon dioxide.

8. A method of preparing a non-alcoholic wine beverage comprising:
(A) mixing:
(a) a dealcoholized wine base; and
(b) a blend of fruit juices; and
(B) carbonating the mixture using a blend of carbonation comprising nitrogen and carbon dioxide.

9. The method of claim 8 wherein the dealcoholized wine base includes a Sauvignon Blanc dealcoholized wine base, and the blend of carbonization includes about 20%-30% nitrogen and about 70%-80% carbon dioxide.

10. The method of claim 9 wherein the blend of carbonation includes about 25% nitrogen and about 75% carbon dioxide.

11. The method of claim 8 wherein the dealcoholized wine base includes a dealcoholized Rose' wine base, and the blend of carbonation includes about 40%-60% nitrogen and about 40%-60% carbon dioxide.

12. The method of claim 11 wherein the blend of carbonation includes about 50% nitrogen and about 50% carbon dioxide.

13. The method of claim 8 wherein the dealcoholized wine base includes a dealcoholized Cabernet Sauvignon wine base, and the blend of carbonation includes about 20%-30% nitrogen and about 70%-80% carbon dioxide.

14. The method of claim 13 wherein the blend of carbonation includes about 25% nitrogen and about 75% carbon dioxide.
